(19) United States
(12) Patent Application Publication
(10) Pub. No.: US 2020/0095815 A1
(43) Pub. Date: Mar. 26, 2020

(54) Improved Bifold System

(71) Applicant: Bi-Fold Systems Limited, Hamilton (NZ)

(72) Inventors: Grant Raymond Muldrock, Whangarei (NZ); Vernon Keith Muldrock, Whangarei (NZ)

(21) Appl. No.: 16/619,075

(22) PCT Filed: May 31, 2018
(86) PCT No.: PCT/NZ2018/050077

§ 371 Date: Dec. 3, 2019

(30) Foreign Application Priority Data
Jun. 12, 2017 (NZ) 732588

(51) Int. Cl. E05D 15/26; E06B 3/48; E05D 5/06

(52) U.S. Cl. CPC E05D 15/264; E05Y 2900/132; E05D 5/06; E06B 3/481

(57) ABSTRACT

A bifold system, in at least one iteration, includes a frame having a jamb and a header; a track extending along the header; a first panel and a second panel each having a first side and a second side opposite the first side, the first panel being hinged to the jamb at the first side of the first panel to pivot about a vertical axis spaced with respect to the track; an intermediate hinge(s) connecting the second panel to the first panel, the intermediate hinge(s) enabling the panels to be opened and closed; a wheel connected towards the second side of the second panel, the wheel being rotatably and vertically mounted to travel along the track. When the panels are in the open configuration, the intermediate hinge(s) offsets the second side of the first panel from the first side of the second panel by a spacing in the forward direction.

### I. FIELD OF THE INVENTION

The invention relates to a bifold system, parts thereof and a related method.

### II. BACKGROUND OF THE INVENTION

A bifold system typically comprises an assembly of two or more panels mounted within a frame. When the panels are closed, the panels may be substantially parallel to each other and aligned parallel to the frame so that they span across the frame to close off an opening defined by the frame. To open the panels, the panels may be pivoted and moved so that the panels collapse next to each other on one side of the frame so that they are parallel to each other but perpendicular to the frame, leaving most of the opening defined by the frame open. Bifold systems have been used to form doors, windows and cabinets, for example.

Many bifold systems involve hardware to attach door panels to each other and to a door frame. Traditional bifold systems may have complicated pivoting and travelling hardware which may be expensive, complex and time consuming to install, prone to wear, and/or needing frequent readjustment. Many traditional bifold systems may be weak and may be prone to misalignment over time.

Additionally, some bifold systems require door panels of different sizes in order to accommodate for pivoting and movement of the door panels. A bifold system with different size panels may be unappealing to the eye given the lack of symmetry. Moreover, a system with different size panels may be more expensive to manufacture and supply compared to systems where the same door panel is used for both panels.

Furthermore, some existing bifold systems may comprise tracks or rails at the top and/or bottom of the door frame for guiding and/or supporting travelling hardware. In some designs, the tracks or rails may need to be mounted so as to extend into the doorway, which may be unappealing to the eye and may reduce the effective size of the door frame.

### III. OBJECT OF THE INVENTION

It is an object of the invention to provide an improved bifold system such as a bifold panel or window system.

Alternatively, it is an object of the invention to provide improved hardware for use in a bifold system.

Alternatively, it is an object of the invention to provide an improved kit for use in installing a bifold system.

Alternatively, it is an object of the invention to provide an improved method of constructing a bifold system.

Alternatively, it is an object of the invention to provide an improved hinge for connecting panels of a bifold system.

Alternatively, it is an object of the invention to at least provide the public with a useful choice.

### IV. SUMMARY OF THE INVENTION

According to a first aspect of the invention there is provided a bifold system comprising:
a frame comprising a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the frame;
a second panel having a first side and a second side opposite the first side;
at least one intermediate hinge connecting the first side of the second panel to the second side of the first panel, the at least one intermediate hinge enabling the first panel and the second panel to be moved between a closed configuration and an open configuration;
a wheel connected to the second panel towards the second side of the second panel, the wheel being rotatably mounted on a vertical axis and configured to guidedly travel along the track, and
wherein, when the first panel and the second panel are in the open configuration, the intermediate hinge offsets the second side of the first panel from the first side of the second panel by a spacing in the forward direction.

A forward direction with respect to the opening and frame is to be understood as a direction perpendicular to the plane of the opening and away from the opening on the side of the frame on which the first and second panels are positioned in the open configuration.

The bifold system may take the form of a bifold door system in which the first panel and the second panel each comprise door panels. Preferably, the bifold system comprises a doorway. In other embodiments, the bifold system comprises a cabinet door system.

In other embodiments, the bifold system may take the form of a bifold window system in which the first panel and the second panel comprise window panels.

Preferably, the intermediate hinge comprises a first hinge leaf and a second hinge leaf connected to the first hinge leaf, the first hinge leaf and second hinge leaf being pivotable with respect to each other about a common axis, the first hinge leaf being mounted to the first panel and the second hinge leaf being mounted to the second panel.

Preferably, the common axis is spaced from the second side of the first panel towards the first side of the first panel.

Preferably, each of the first hinge leaf and the second hinge leaf comprises a first hinge leaf portion extending away from the common axis and a second hinge leaf portion extending away from the first hinge leaf portion at an angle to the first hinge leaf portion. Preferably, the angle to the first hinge leaf portion is substantially 90 degrees.

Preferably, the second hinge leaf portion of the first hinge leaf is secured to a surface on an edge of the first panel, and the second hinge leaf portion of the second hinge leaf is secured to a surface on an edge of the second panel.

Preferably, when the first panel and second panel are in the closed configuration, the second hinge leaf overlaps the first hinge leaf. Preferably, when the first panel and the second panel are in the open configuration, the first hinge leaf is located on an opposite side of the common axis to the second hinge leaf.

Preferably, when the first panel and second panel are in the closed configuration, the first hinge leaf portion is aligned parallel with and abutting the first hinge leaf portion of the second hinge leaf, and the second hinge leaf portion of the first hinge leaf is aligned parallel with and abutting the second hinge leaf portion of the second hinge leaf.

Preferably, when the first panel and second panel are in the open configuration, the second hinge leaf portion of the first hinge leaf is parallel to and spaced from the second hinge leaf portion of the second hinge leaf in the forward direction by the spacing of the second side of the first panel from the first side of the second panel.

Preferably, each of the first hinge leaf and the second hinge leaf are configured to fit within a hinge rebate having a height of 90 mm. In some embodiments, the second hinge leaf portion of each of the first hinge leaf and the second hinge leaf are configured to fit within a hinge rebate having a width of 30 mm.

Preferably, the first hinge leaf and the second hinge leaf each comprise holes configured to receive fasteners for securing the hinge to the first panel and the second panel.

In some embodiments, the bifold system comprises two intermediate hinges connecting the first panel and the second panel. In some embodiments, the bifold system comprises three intermediate hinges connecting the first panel and the second panel.

Preferably, the track comprises a track member mounted to the header.

Preferably, the header comprises a recess configured to receive the track member, and the track member is mounted to the header in the recess. Preferably, the recess is a slot along the header above the opening.

Preferably, the track comprises a channel shape. Preferably, the track member comprises a channel shaped member. Preferably, the track member is supported by the header to open downwardly.

In some embodiments, the track member comprises an extrusion. In some embodiments, the track member comprises an aluminium extrusion.

Preferably, the wheel is configured to roll along sides of the track.

Preferably, the wheel is rotatably mounted on a wheel bracket, the wheel bracket being mounted to the second panel.

Preferably, the wheel bracket is mounted to a top edge of the second panel. Preferably, the wheel bracket is mounted proximate a second side of the second panel.

Preferably, the wheel bracket comprises a body configured to be fixed to the second panel. Preferably the body is planar.

Preferably, the body of the wheel bracket comprises holes configured to receive fasteners with which the wheel bracket can be fixed to the second panel.

Preferably, the wheel is mounted on the wheel bracket with a bearing assembly. Preferably the bearing is a ball bearing assembly.

According to a second aspect of the invention there is provided a bifold kit for a bifold system, the bifold system comprising:
a frame having a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the opening; and
a second panel having a first side and a second side opposite the first side of the second panel,
   the bifold kit comprising:
at least one intermediate hinge configured to connect the first side of the second panel to the second side of the first panel, the intermediate hinge enabling the first panel and the second panel to be moved between a closed configuration and an open configuration;
a wheel configured to be connected to the second panel towards the second side of the second panel so as to be rotatably mounted on a vertical axis and configured to guidedly travel along the track, and
wherein when the first panel and the second panel are in the open configuration, the intermediate hinge offsets the first side of the second panel from the second side of the first panel by a spacing in the forward direction.
   Preferably, the bifold kit comprises a wheel bracket having a body configured to be mounted to the second panel.

Preferably, the kit comprises a track member configured to be mounted to the header, the track member configured to receive the wheel and guide the wheel to travel along the track.

According to a third aspect of the invention there is provided a bifold system comprising:
a frame comprising a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the opening;
a second panel having a first side and a second side opposite the first side;
at least one intermediate hinge connecting the first side of the second panel to the second side of the first panel, the at least one intermediate hinge enabling the first panel and the second panel to be moved between a closed configuration and an open configuration;
a wheel connected to the second panel towards the second side of the second panel, the wheel being rotatably mounted on a vertical axis and configured to guidedly travel along the track, and
wherein the at least one intermediate hinge comprises a first hinge leaf and a second hinge leaf connected to the first hinge leaf, the first hinge and second hinge leaf configured to pivot with respect to each other about a common axis, and each of the first hinge leaf and second hinge leaf having a first hinge leaf portion extending away from the common axis and a second hinge leaf portion extending away from the first hinge leaf portion at an approximately perpendicular angle to the first hinge leaf portion.

According to a fourth aspect of the invention there is provided a method of installing a bifold system in a frame comprising a jamb and a header together at least partially defining an opening, the method comprising:
providing a track extending along the header in a transverse direction across the opening;
hingedly connecting a first side of a first panel to the jamb so as to pivot about a vertical axis spaced with respect to the track in a forward direction with respect to the opening;
connecting a first side of a second panel to a second side of the first panel opposite the first side of the first panel with at least one intermediate hinge enabling the first panel and the second panel to be moved between a closed configuration and an open configuration;
connecting a wheel to the second panel towards a second side of the second panel such that the wheel is rotatably mounted on a vertical axis and configured to guidedly travel along the track;
wherein when the first panel and the second panel are in the open configuration, the intermediate hinge offsets the second side of the first panel from the first side of the second panel from the second side of the first panel by a spacing in the forward direction.

Preferably, the method comprises mounting a wheel bracket to the second panel, the wheel bracket having the wheel rotatably mounted thereon.

Preferably, the method comprises mounting a track member to the header, the track member configured to guide the wheel to travel along the track member.

According to another aspect of the invention there is provided an intermediate hinge for a bifold system according to the first or third aspects of the invention, the intermediate hinge comprising:
a first hinge leaf and a second hinge leaf connected to the first hinge leaf, the first hinge and second hinge leaf configured to pivot with respect to each other about a common axis;
wherein the intermediate hinge is configured to connect the first side of the second panel to the second side of the first panel and enable the first panel and the second panel to be moved between a closed configuration and an open configuration,
wherein when the first panel and the second panel are in the open configuration, the intermediate hinge offsets the second side of the first panel from the first side of the second panel by a spacing in the forward direction.

Preferably, each of the first hinge leaf and the second hinge leaf comprises a first hinge leaf portion extending away from the common axis and a second hinge leaf portion extending away from the first hinge leaf portion at an angle to the first hinge leaf portion.

Preferably, the angle to the first hinge leaf portion is substantially 90 degrees.

Further aspects of the invention, which should be considered in all its novel aspects, will become apparent to those skilled in the art upon reading of the following description which provides at least one example of a practical application of the invention.

### V. BRIEF DESCRIPTION OF THE DRAWINGS

The invention will now be described by way of example only and with reference to the appended drawings, in which:

FIG. 1a is a perspective view illustration of a bifold system according to an embodiment of the invention, in a partially open configuration;

FIG. 1b is a perspective view illustration of the bifold system of FIG. 1a, in an open configuration;

FIG. 1c is a perspective view illustration of a track of the bifold system of FIG. 1a, in a partially open configuration;

FIG. 2a is a schematic plan view illustration of a bifold system according to the embodiment of FIG. 1a, in a closed configuration;

FIG. 2b is a schematic plan view illustration of a bifold system according to the embodiment of FIG. 1a, in a partially open configuration;

FIG. 2c is a schematic plan view illustration of a bifold system according to the embodiment of FIG. 1a, in an open configuration;

FIG. 3a is a plan view illustration of a wheel bracket according to an embodiment of the invention;

FIG. 3b is a side view illustration of the wheel bracket of FIG. 3a;

FIG. 3c is a cross-section view illustration of the wheel bracket of FIG. 3a mounted to a panel and with a wheel of the wheel bracket located within a track in a header of a frame;

FIG. 4a is a plan view illustration of a first hinge leaf of an intermediate hinge according to one embodiment;

FIG. 4b is plan view illustration of a second hinge leaf of an intermediate hinge according to the embodiment of FIG. 4a;

FIG. 4c is a plan view illustration of an intermediate hinge comprising the first hinge leaf of FIG. 4a and the second hinge leaf of FIG. 4b, in a closed configuration;

FIG. 4d is a plan view illustration of the intermediate hinge of FIG. 4d, in an open configuration;

FIG. 5a is a schematic plan view illustration of a portion of a bifold system according to one alternative embodiment of the invention;

FIG. 5b is a schematic plan view illustration of a portion of a bifold system according to another alternative embodiment of the invention; and

FIG. 5c is a schematic plan view illustration of a portion of a bifold system according to another alternative embodiment of the invention.

### VI. DETAILED DESCRIPTION OF EMBODIMENTS OF THE INVENTION

Preferred embodiments of the invention relate to a bifold system having a first panel hinged to a jamb of a frame, and a second panel hinged to the first panel. The frame has a track along the header within which a wheel mounted to the second panel can travel to guide the second panel. The first panel may be hinged to pivot about a vertical axis forward of the frame and the track, while the second panel pivots about the wheel in the track. As the first panel and second panel are preferably the same size, when the panels are open the edge of the second panel that is hinged to an edge of the first panel is spaced back towards the frame. The hinges used to connect the first panel and second panel are configured to open out to space the edge of the second panel back towards the frame. The bifold system according to embodiments of the invention are suited to doors, windows and the like.

The hinges and wheel in embodiments of the invention may be more reliable and less prone to causing misalignment than some prior art technology, as well as being more time and cost effective to manufacture and install, while allowing the two panels to be of the same size and without substantial gaps when closed. A bifold system in which the two panels are of the same size may be more visually appealing than a system with different size panels and may reduce the cost of manufacturing and supplying bifold systems. It may be more cost effective to manufacture the same panel twice than to manufacture two panels of different designs. Although, in some embodiments two different panels having the same size may be utilised, for example to provide different (e.g. symmetrical) visual features to the panels. Furthermore, small gaps between the panels may be more appealing to the eye and provide a better closure of the opening.

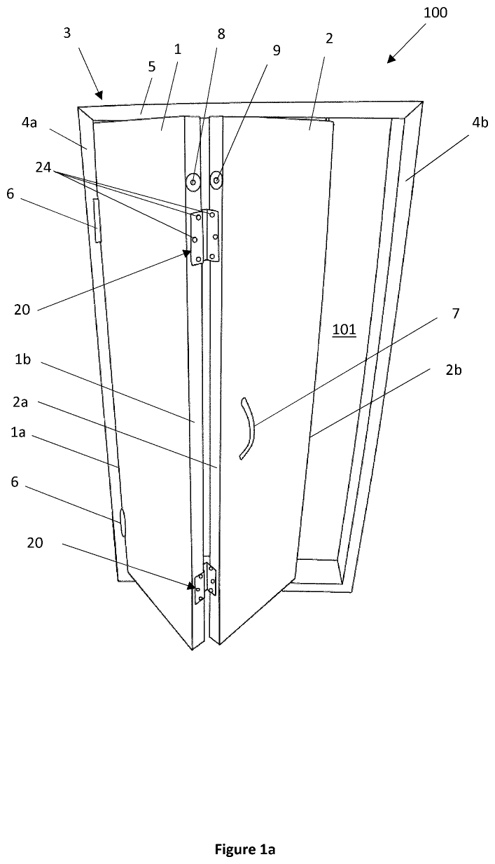

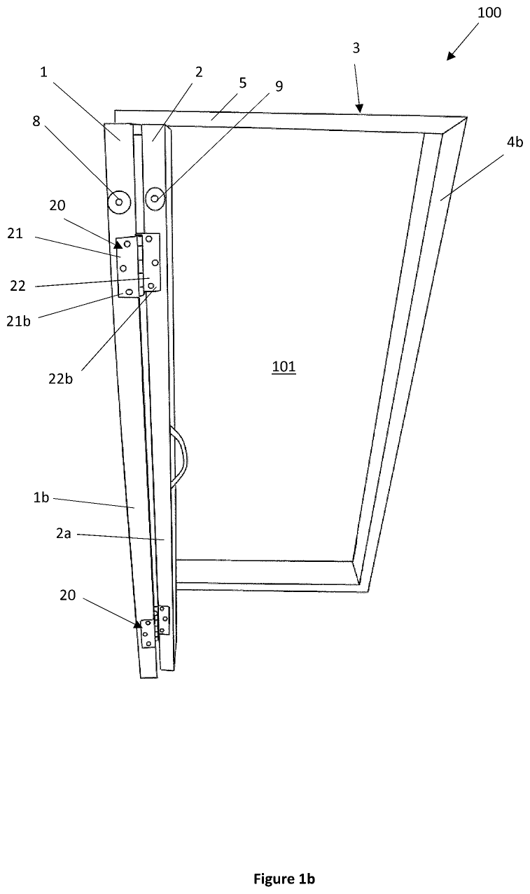

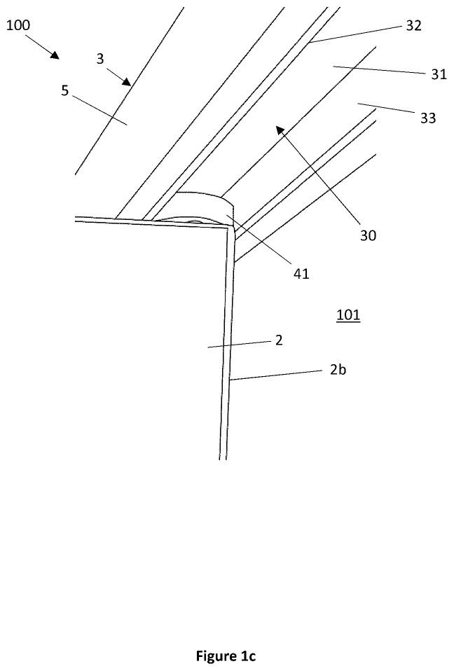

FIG. 1a shows a bifold system 100 according to one preferred embodiment of the invention in a partially open configuration. The bifold system 100 may be branded with Bi-Fold Systems™. The bifold system 100 comprises a first panel 1 and a second panel 2. The bifold system 100 comprises a frame 3 within which the first panel 1 and second panel 2 are supported. The frame 3 comprises a jamb 4a and a header 5. The jamb 4a and header 5 at least partially define an opening 101 of the bifold system 100. The jamb 4a comprises a vertical side portion of the frame 3, to which the first panel 1 is hinged. The header 5 comprises a horizontal top portion of the frame 3 which may also be known as a lintel of the frame 3.

In this preferred embodiment the bifold system 100 comprises a bifold door system. Accordingly, the first panel 1 and second panel 2 are door panels and the frame comprises a door frame. In this embodiment the bifold door system forms a passage way for people to pass through. In other embodiments the bifold door system may form the doors of a cabinet, cupboard or the like. In other embodiments, the bifold system may comprise a bifold window system and the first panel and second panel may be windows.

In the exemplary embodiment, the bifold system 100 comprises a frame with two jambs 4a and 4b, defining both sides of the opening. However, in other embodiments the bifold system may be configured to for installation or constructions against a wall perpendicular to the opening, wherein the wall defines a vertical side of the opening. In some embodiments, the frame may comprise a sill portion defining a bottom side of the opening. In other embodiments the bifold panel assembly may be configured for installation or construction over a floor surface without a sill, in which case the frame may not have an frame portion at the bottom thereof.

The first panel 1 is hinged to the jamb 4a. More particularly, the first panel 1 is hinged to the jamb 4a at a first side 1a of the first panel 1. The first panel 1 is hinged to the jamb 4a to pivot about a vertical axis located proximate a forward surface of the frame 3. The first panel 1 is hinged to the jamb 4a using frame hinges 6 which in this embodiment are conventional door hinges, e.g. butt hinges. The frame hinges 6 are mounted to the jamb 4a so that the hinge barrels are proud of the forward edge of the frame 3. The first side 1a of the first panel 1 is therefore able to closely abut the inside surface of the jamb 4a of the frame 3 when the first panel 1 and second panel 2 are in a closed configuration, leaving little to no space between the first side 1a of the first panel 1 and the jamb 4a. Additionally, when in the closed configuration, the forward face of the first panel 1 is a flush with the forward edges of the frame.

A forward direction with respect to the opening is, for the purposes of this specification and unless the context clearly indicates otherwise, to be understood as a direction perpendicular to the plane of the opening/frame and away from the opening on the side of the frame on which the first and second panels are positioned in the open configuration.

The bifold system 100 also comprises two intermediate hinges 20 connecting a first side 2a of the second panel 2 to a second side 1b of the first panel 1. Each intermediate hinge may be a Bi-Fold Systems™ hinge. The second side 1b of the first panel 1 is opposite to the first side 1a of the first panel 1. The intermediate hinges 20 enable the second panel 2 to pivot relative to the first panel 1, and enable the first panel 1 and the second panel 2 to be moved between the closed configuration and the open configuration of the bifold system 100. In the closed configuration, the first panel 1 and second panel 2 are substantially parallel to each other and parallel to the opening 101 with their second and first sides respectively substantially abutting so as to span across and close off the opening 101. FIG. 1b shows the bifold system 100 in an open configuration. In the open configuration, the first panel 1 and second panel 2 are substantially parallel to each other but perpendicular to the opening 101. The first panel 1 and second panel 2 have been folded together towards at the side of the frame 3 to which the first panel 1 is hinged. The partially open configuration of the bifold system 100 shown in FIG. 1a illustrates this folding movement in progress. It will be appreciated that, in other embodiments of the invention, the position of the panels in a “fully” open configuration may vary depending on, for example, the use of stops or the like.

In different embodiments of the invention, the bifold system or kit therefore may comprise any number of intermediate hinges connecting the first panel and the second panel, such as one, two, three or more. Two or three hinges may be appropriate for many doors, although a different number may be used depending on the size and weight of the doors. In some embodiments the intermediate hinges may have different lengths depending on the number of hinges used and size and/or weight of the panels. For example, if only one intermediate hinge is used, the intermediate hinge may be of the piano hinge type, e.g. a hinge extending all or a substantial part of the length of the panels, if necessary to support the load of the second panel.

In some embodiments of the invention, the bifold system may comprise a frame with four panels. Two panels may fold towards one side of the frame while two panels may fold towards the other side of the frame, resulting in a double bifold panel assembly. A skilled addressee will understand that the disclosed panel assembly could be extended within a single larger frame to achieve such a system.

A handle 7 is mounted to the second panel 2 to enable a person to move the first panel 1 and second panel 2 between the open and closed configurations.

The bifold panel assembly 100 comprises a pair of magnetic latches 8 and 9. Magnetic latch 8 is mounted to the first panel 1 and magnetic latch 9 is mounted to the second panel 2. More particularly, magnetic latch 8 is mounted in the second side 1b of the first panel 1 and magnetic latch 9 is mounted in the first side 2a of the second panel 2, at the same height as the magnetic latch 8. The magnetic latches 8 and 9 are configured to align with each other when the panels are in the closed configuration and provide a biasing force by magnetic attraction towards each other to hold the first panel 1 and second panel 2 in the closed position.

FIG. 1c is a perspective view showing the underside of the header 5 while the bifold system 100 is in the partially open configuration shown in FIG. 1a. The header 5 of the bifold system 100 comprises a track 30 which is visible in FIG. 1c. The track 30 extends along the header 5. Accordingly, the track 30 extends in a transverse direction across the opening 101.

The bifold system 100 comprises a wheel 41 connected to the second panel 2 towards or proximate the second side 2b of the second panel 2. The wheel 41 is rotatably mounted on a vertical axis and is configured to guidedly travel along the track 30. The wheel is configured to roll along sides of the track 30 (but may only roll along one side at any particular instant). In this embodiment, the sides of the track 30 are vertically oriented surfaces that extend along the length of the track 30.

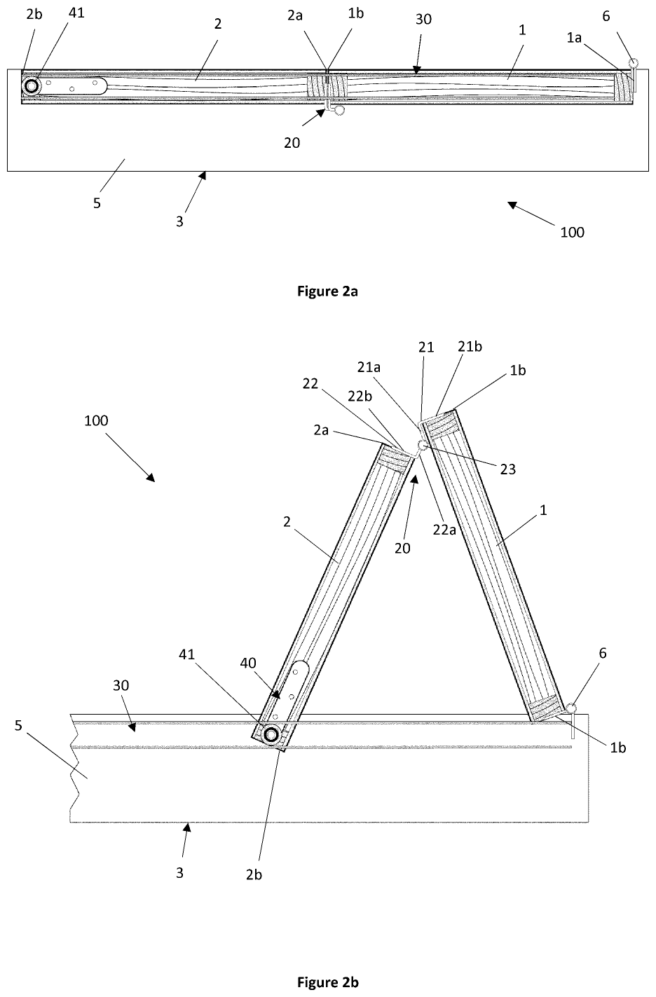

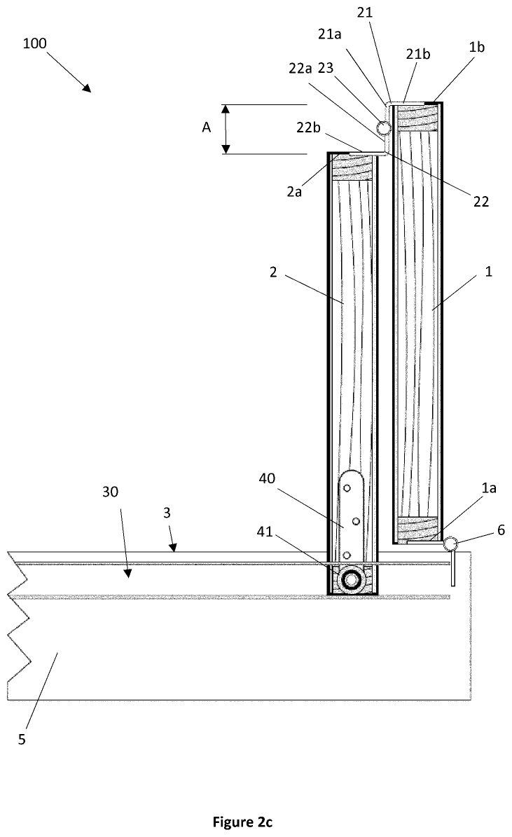

FIGS. 2a, 2b and 2c show schematic plan views of the bifold system 100 in closed, partially open and open configurations, respectively. The header 5 of the frame 3 is indicated, but is shown transparently enabling the first panel 1, second panel 2, track 30 and wheel 41 to be shown, along with other related parts of the bifold system 100.

The wheel 41 constrains the movement of the second panel 2 given the second panel 2 is only able to move in such a way that wheel 41 remains within the track 30. Since the wheel 41 is constrained to travel within the track 30, when the first panel 1 and second panel 2 are moved from the closed configuration to the open configuration, the second panel 2 pivots about the axis of the wheel 41 (although it should be noted that this axis also moves as the wheel 41 travels along the track 30). As shown in FIG. 1c, the track 30 is located rearwardly from the forward surfaces of the frame. Locating the track 30 rearwardly of the forward surfaces of the frame 3 allows the track 30 to be recessed within the frame, which advantageously minimises or eliminates intrusion of track 30 into the opening 101, and hides it from view, which may be more visually appealing.

Since the track 30 is spaced rearwardly of the forward surface of the frame 3, the second panel 2 pivots about an axis spaced rearwardly of the forward surface of the frame 3 (since it pivots about the axis of the wheel 41). Additionally, since the frame hinges 6 are mounted with barrels located forwardly of the forward surface of the frame 3, the first panel 1 pivots about an axis spaced forwardly of the forward surface of the frame 3. The offset between the axis of rotation of the first panel 1 with respect to the frame and the axis of rotation of the second panel 2 with respect to the frame has an effect on the positioning of the panels in the open configuration. In the closed configuration, the first panel 1 and second panel 2 are aligned parallel to each other in the same plane, with the second side 1b of the first panel 1 abutting the first side 2a of the second panel 2. However, since the panels are of the same size when the panels 1 and 2 pivot while moving to the open configuration, the offset in the forward direction of the axis of rotation of the first panel 1 from the axis of rotation of the second panel 2 results in the second side 1b of the first panel 1 being positioned forwardly of the first side 2a of the second panel 2 in the open position 1. This results in a spacing A from the second side 1b of the first panel 1 to the first side 2a of the second panel 2 towards the frame 3. The second side 1b of the first panel 1 is offset from the first side 2a of the second panel 2 by the spacing A in the forward direction.

To enable the first panel 1 and second panel 2 to move from the closed configuration to the open configuration, the intermediate hinges 20 are configured to provide for the spacing A between the second side 1b of the first panel 1 and the first side 2a of the second panel 2 in the forward direction. Each intermediate hinge 20 offsets the second side 1b of the first panel 1 from the first side 2a of the second panel 2 by the spacing A in the forward direction.

As shown in FIGS. 2a-c, as the first panel 1 and the second panel 2 are moved from the closed configuration shown in FIG. 2a through the partially open configuration shown in FIG. 2b to the open configuration shown in FIG. 2c, the intermediate hinges 20 are configured to open or expand to increase the spacing between the second side 1b of the first panel 1 and the first side 2a of the second panel 2. Similarly in reverse, the intermediate hinges 20 are configured to close or contract to reduce the spacing between the second side 1b of the first panel 1 and the first side 2a of the second panel 2. The intermediate hinges 20 are configured to spread apart/separate the second side 1b of the first panel 1 and the first side 2a of the second panel 2 apart (e.g. increase the distance between the edges of the panels) to offset the first panel 1 from the second panel 2 by a spacing in the forward direction. When the panels are in the open configuration, the spacing A is a spacing or offset in a forward/rearward direction with respect to the opening 101. That is, a perpendicular direction to the opening of the opening 101.

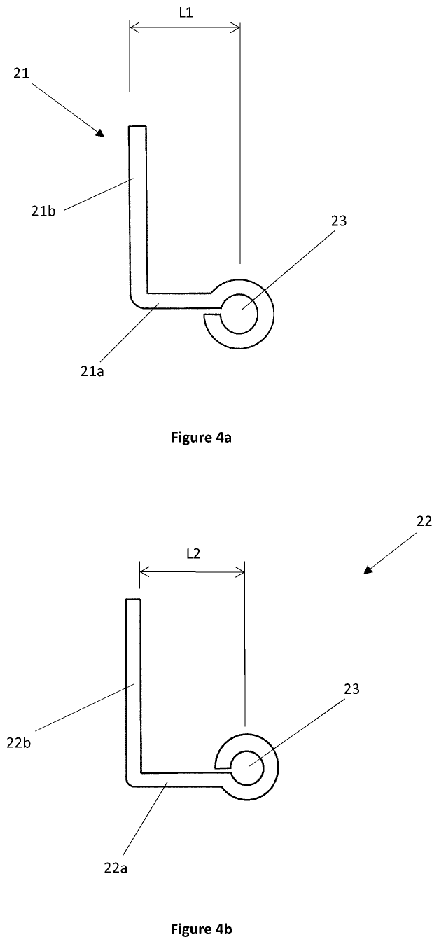

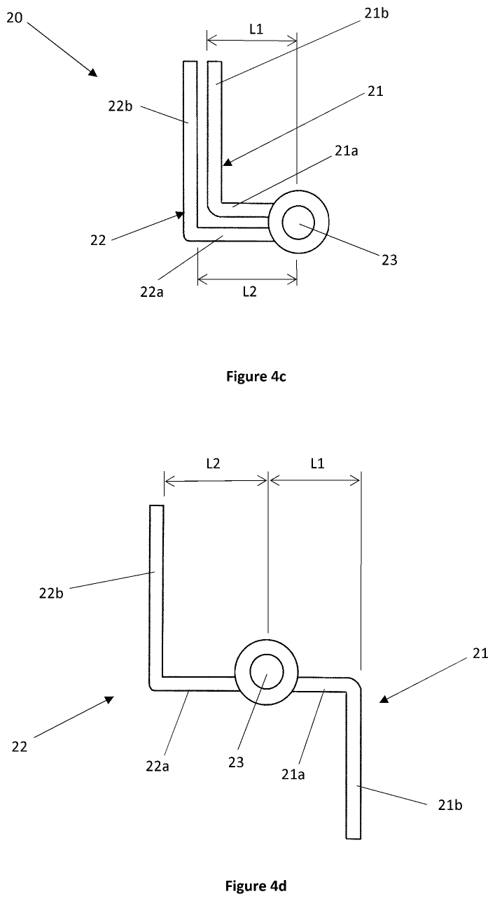

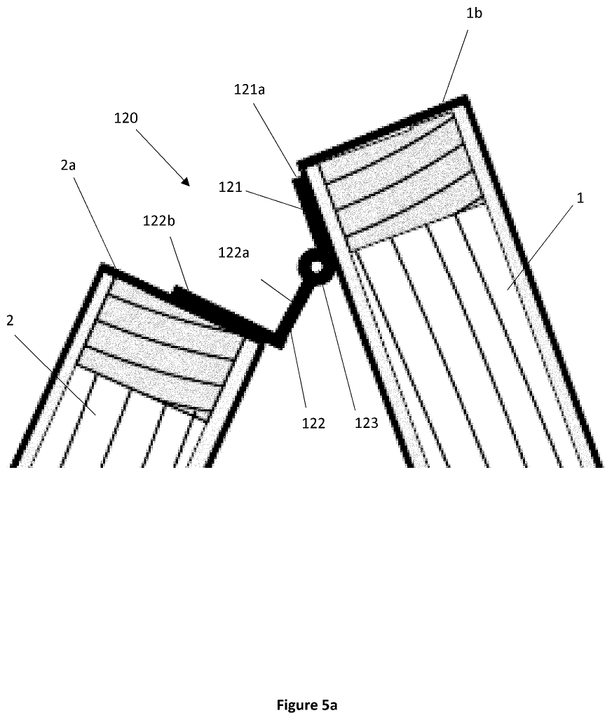

As shown in FIGS. 2a-c and FIGS. 4a-d, each intermediate hinge 20 comprises a first hinge leaf 21 and a second hinge leaf 22. The first hinge leaf 21 and second hinge leaf 22 are connected to each other and pivotable with respect to each other about a common axis. In this embodiment, each intermediate hinge 20 comprises a hinge barrel 23 defining the common axis about which the hinge leaves 21 and 22 pivot with respect to each other.

In this embodiment, the first hinge leaf 21 comprises a first hinge leaf portion 21a extending away from the hinge barrel 23 and common axis. The first hinge leaf 21 also comprises a second hinge leaf portion 21b extending away from the first hinge leaf portion 21a at an angle to the first hinge leaf portion 21a. Similarly, the second hinge leaf 22 comprises a first hinge leaf portion 22a extending away from the hinge barrel 23 and common axis. The second hinge leaf 22 also comprises a second hinge leaf portion 22b extending away from the first hinge leaf portion 22a at angle to the first hinge leaf portion 22a. In this embodiment, the angle at which each of the second hinge leaf portions 21b and 22b extend away from the respective first hinge leaf portions 21a and 22a is substantially 90 degrees (i.e. a perpendicular angle). Other angles, including angles close to 90 degrees, would also work although they may result in a larger transverse gap (e.g. a wider gap when viewed in a direction towards the frame) between the panels when the panels are in the open configuration. In this embodiment, each hinge leaf 21 and 22 comprises a curve between the first hinge leaf portion and the respective second hinge leaf portion, which may be formed by a bending operation. As shown in the FIG.FIGs., the hinge leaves of the intermediate hinges 20 are L-shaped.

The hinge leaf portions may have different widths (or may be described as lengths, for example when viewed from above as shown in FIGS. 2a-c and 4a-d). For example, the first hinge leaf portions 21a and 22a are wider than the second hinge leaf portions 21b and 22b. The widths of the first hinge leaf portions 21a and 22a are selected to provide the necessary spacing between the first panel 1 and second panel 2 when the panels are in the open configuration, whereas the widths of the second hinge leaf portions 21b and 22b are selected to fit within standard size hinge rebates (e.g. the same size rebates that are cut into door panels to receive conventional hinges). The dimensions of each portion of the hinge leaves are discussed in more detail below.

As shown, the first hinge leaf 21 is connected to the first panel 1 and the second hinge leaf 22 is connected to the second panel 2. More specifically, the second hinge leaf portion 21b of the first hinge leaf 21 is secured to the edge of the first panel 1 at the second side 1b, and the second hinge leaf portion 22b of the second hinge leaf 22 is secured to the edge of the second panel 2 at the first side 2a.

When the first panel 1 and the second panel 2 are in the closed position as shown in FIG. 2a, the second hinge leaf 22 overlaps the first hinge leaf 21. The second hinge leaf 22 fits around the first hinge leaf 21. The first hinge leaf portion 21a of the first hinge leaf 21 is aligned parallel with and lies alongside the first hinge leaf portion 22a of the second hinge leaf 22. Similarly, the second hinge leaf portion 21b of the first hinge leaf 21 is aligned parallel with and lies alongside the second hinge leaf portion 22b of the second hinge leaf. However, when the first panel 1 and the second panel 2 are in the open configuration, as shown in FIG. 2c, the second hinge leaf 22 is located on an opposite side of the hinge barrel 23 and common axis to the first hinge leaf 21. In this configuration the second hinge leaf portion 21b of the first hinge leaf 21 is parallel to and offset from the second hinge leaf portion 22b of the second hinge leaf 22 in the forward direction by the spacing A between the second side 1b of the first panel 1 and the first side 2a of the second panel 2.

Other hinge designs that also enable the required spacing between the edges of the first panel and second panel are used as intermediate hinges in alternative embodiments of the invention. One potential advantage of the L-shaped design of the intermediate hinges 20 described above is this design enables the hinge leaves to be secured to the edges of doors rather than to the faces of the doors. The hinge leaves 21 and 22 are advantageously able to fit into the same size and style hinge rebates that are found on the edges of conventional doors. Since a door manufacturer may already have machines and jigs set up to cut hinge rebates into the edges of doors, it may be more economical for the manufacturer to begin manufacturing doors suitable for use in bifold systems according to the present invention. In contrast, it may be more difficult for a manufacturer to reconfigure the equipment to cut rebates into the faces of doors (although an embodiment with such doors does not necessarily fall outside of the scope of the present invention).

Other intermediate hinge designs that may be suitable are those which, when closed, are able to bring the edges of the first panel and second panel substantially together, and when open, are able to separate the edges of the doors by the offset between the second side of the first panel and the first side of the second panel when the doors are in the open configuration. For example, in various alternative embodiments of the invention the bifold system includes intermediate hinges that connect the first side of the second panel to the second side of the first panel, with hinge leaves that connect to either the edges of the doors or the faces of the doors.

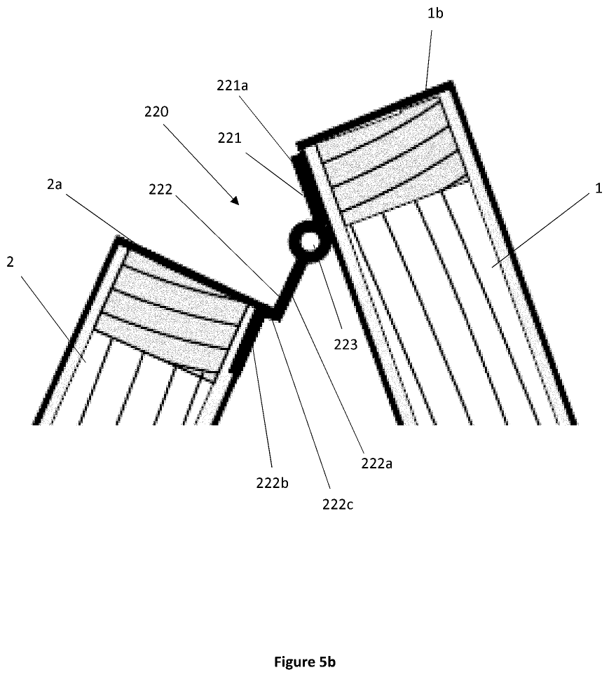

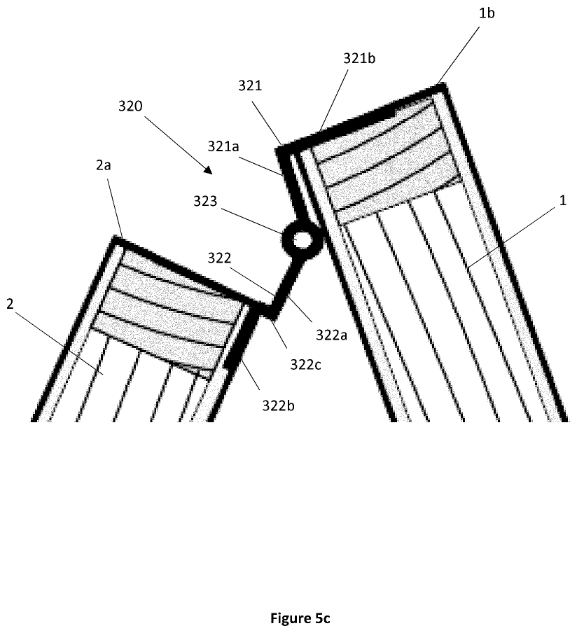

In one alternative embodiment, shown in FIG. 5a, an intermediate hinge 120 connects a first panel 1 and a second panel 2 of a bifold system. The intermediate hinge 120 comprises a first hinge leaf 121 having a first hinge leaf portion 121a similar to the first hinge leaf portion 21a, but with no second hinge leaf portion. Instead, the first hinge leaf portion 121a is configured to be mounted to the face of the first panel 1 proximate the edge at a second side 1b of the first panel 1. The intermediate hinge 120 also comprises second hinge leaf 122 pivotably connected to the first hinge leaf 121 about a hinge barrel 123 which defines a common axis of the first hinge leaf 121 and second hinge leaf 122. The second hinge leaf 122 has substantially the same structure as the second hinge leaf 22 of the intermediate hinge 20. Accordingly, the second hinge leaf 122 comprises a first hinge leaf portion 122a which extends away from the hinge barrel 123 and a second hinge leaf portion 122b that extends away from the first hinge leaf portion 122a. In this embodiment, the second hinge leaf portion 122b extends away from the first hinge leaf portion 121a at a substantially perpendicular angle.

In another alternative embodiment, shown in FIG. 5b, an intermediate hinge 220 which connects a first panel 1 and a second panel 2, has a first hinge leaf 221 substantially as described in the preceding paragraph (i.e. not having a second hinge leaf portion). The intermediate hinge 220 also comprises a second hinge leaf 222 connected to the first hinge leaf at a hinge barrel 223 defining a common axis about which the hinge leaves 221 and 222 are able to pivot. However, the second hinge leaf 222 does not have two perpendicular hinge leaf portions. Instead, the second hinge leaf 222 spans from the hinge barrel 223 to the first side 2a of the second panel 2, and then projects further and connects to the face of the second panel 2 rather than bending 90 degrees and connecting to the edge of the second panel 2. The second hinge leaf 222 is approximately twice the width of the first hinge leaf 221. The second hinge leaf 222 comprises two hinge leaf portions 222a and 222b. In contrast to the intermediate hinge 20, the second hinge leaf portion 222b is parallel to the first hinge leaf portion 222a. The first hinge leaf portion 222a is offset by a small amount away from the second hinge leaf portion 222b and the face of the panel 2 by an offsetting portion 222c. The offsetting portion 222c and the offset it provides prevents the first hinge leaf portion 222a of the second hinge leaf 222 from interfering with the first hinge leaf portion 221a of the first hinge 221 when the first hinge leaf portions 221a and 222a are alongside each other in the closed configuration of the panels 1 and 2, enabling the panels 1 and 2 to align in the same plane.

In a further alternative embodiment, shown in FIG. 5c, an intermediate hinge 320 has a second hinge leaf 322 similar to the second hinge leaf 222 just described (e.g. with a second hinge leaf portion 322b being parallel to a first hinge leaf portion 322a, offset by an offsetting portion 333c, and configured to connect to the face of the second panel 2). However, the intermediate hinge 320 has a first hinge leaf 321 similar to the first hinge leaf 21 of the intermediate hinge 20, comprising two perpendicular hinge leaf portions, first hinge leaf portion 321a and first hinge leaf portion 321b, with a second hinge leaf portion 321b configured to connect to the second edge 1b of the first panel 1. The first hinge leaf portion 321 and second hinge leaf portion 322 are pivotably connected together at a hinge barrel 323.

In preferred embodiments, the intermediate hinges accommodate the required spacing by being pivotably connected to each other so as to rotate about a common axis, the common axis being spaced from the second side of the first panel towards the first side of first panel. As shown in FIGS. 2a-c, the hinge barrel 23 (and common axis) is spaced from the second side 1b of the first panel 1 towards the first side 1a of the first panel. That is, the common axis, when viewed from above (as shown in FIGS. 2-a-c and 5a-c), is offset from the edge of the second side of the first panel 1 in the direction from the second side 1b to the first side 1a of the first panel 1. By designing the intermediate hinge 20 in this way, the second hinge leaf 22 opens out and back towards the frame 3 to offset the first panel 1 from the second panel 2 in the forward direction while in the open configuration.

FIG. 4a shows the first hinge leaf 21 in isolation. The first hinge leaf portion 21a of the first hinge leaf 21 extends away from the barrel 23 and is partially swaged towards the centreline of the barrel 23. The second hinge leaf portion 21b extends away from the first hinge leaf portion 21a at a substantially perpendicular angle. The second hinge leaf portion 21b extends from the first hinge leaf portion 21a in a direction away from the centreline of the hinge barrel 23 so as to not cross the centreline. The first hinge leaf portion 21a spaces the second hinge leaf portion 21b from the central axis of the hinge barrel 23. This spacing may be known as “throw”. The first hinge leaf 21 comprises a throw L1, which is the spacing from the axis of the hinge barrel 23 to the outside surface of the second hinge leaf portion 21b. When the intermediate hinge 20 is installed on the bifold panel assembly 100, the throw L1 is equal to the spacing between the central axis of the hinge barrel 23 and the edge of the second side 1b of the first panel 1. The throw L1 extends to the outside surface of the second hinge leaf portion 21b because in this preferred embodiment, the second hinge leaf portion 21b is rebated into the edge of the first panel 1 to lie flush with the edge of the first panel 1, while the first hinge leaf portion 21a lies alongside the first panel 1. Accordingly, the edge of the first panel 1 is flush with the outside surface of the second hinge leaf portion 21b.

FIG. 4b shows the second hinge leaf 22 in isolation. The first hinge leaf portion 22a of the second hinge leaf 22 extends away from the hinge barrel 23 and is partially swaged towards the central axis of the hinge barrel 23. The second hinge leaf portion 22b extends away from the first hinge leaf portion 22a at a substantially perpendicular angle to the first hinge leaf portion 22a. The second hinge leaf portion 22b extends from the first hinge leaf portion 22a in a direction across the centreline of the of the hinge barrel 23. The first hinge leaf portion 22a spaces the second hinge leaf portion 22b from the central axis of the hinge barrel 23. The first hinge leaf portion 22a therefore provides the hinge leaf 22 with a throw L2 equal to the spacing between the central axis of the hinge barrel 23 and the inside surface of the second hinge leaf portion 22b. When the intermediate hinge 20 is installed in the bifold panel assembly 100, the throw L2 is equal to the spacing between the central axis of the hinge barrel 23 and the edge of the first side 2a of the second panel 2. The throw L2 extends to the inside surface of the second hinge leaf portion 22b because the second hinge leaf portion 22b is rebated into the edge of the second panel 2 to lie flush with the edge of the second panel 2, while the first hinge leaf portion 22a lies away from the second panel 2 rather than alongside it in the way the first hinge leaf portion 21a of the first hinge leaf 21 lies alongside the first panel 1. Accordingly, the edge of the second panel 2 is flush with the inside surface of the second hinge leaf portion 22b.

FIG. 4c shows the first hinge leaf 21 and second hinge leaf 22 assembled together to form the intermediate hinge 20, in a closed configuration. The intermediate hinge 20 is in this closed configuration when the first panel 1 and second panel 2 of the bifold system 100 are in the closed configuration. As the second hinge leaf portion 21b of the first hinge leaf 21 is connected to the first panel 1, when the bifold system 100 is assembled, and the second hinge leaf portion 22b of the second hinge leaf 22 is connected to the second panel 2, the first panel 1 and second panel 2 are brought together so that the second side 1b of the first panel 1 is adjacent the first side 2a of the second panel 2. The gap between the second side 1b of the first panel 1 and the first side 2a of the second panel 2 is equal to the clearance between the second hinge leaf portion 21b and the second hinge leaf portion 22b of the first and second hinge leaves, which is equal to the difference between the throws L1 and L2.

FIG. 4d shows the first hinge leaf 21 and second hinge leaf 22 assembled together to form the intermediate hinge 20, in an open configuration. The intermediate hinge 20 is in this open configuration when the first panel 1 and the second panel 2 are in the open configuration. The first hinge leaf 21 and second hinge leaf 22 are pivoted with respect to each other about the hinge barrel 23. The throw L1 of the first hinge leaf 21 and the throw L2 of the second hinge leaf 22 combine to separate the second hinge leaf portions 21b and 22b by the sum of the two throws L1 and L2. Since the second hinge leaf portions 21b and 22b are connected to the edges of the first panel 1 second panel 2, the intermediate hinge 20 functions to separate the edges of the first panel 1 and second panel 2 by the sum of the throws L1 and L2 of the first and second hinge leaves 21 and 22. Since the first panel 1 and second panel 2, in the open configuration shown in FIG. 2c, are parallel to each other and extending forward of the frame 3, the sum of the throws L1 and L2 is equal to the spacing A of the second edge 1b of the first panel 1 from the first edge 2a of the second panel 2 in the forward direction of the opening 101.

It may be advantageous for the amount of throw (e.g. spacing/offset) provided by the intermediate hinges 20 to be matched closely to the spacing between the edges of the panels 1 and 2 in the forward direction when the panels 1 and 2 are in the open configuration, as this facilitates the panels opening into parallel alignment with each other and perpendicular to the frame 3. The spacing between the edges of the first panel 1 and second panel 2 connected by the intermediate hinges 20 is itself affected by the offset between the axis about which the first panel 1 pivots (the axis of the barrels of the hinges 6) from the axis about which the second panel 2 pivots (the axis on which the wheel 41 is mounted). This offset is affected by the spacing in the forward direction of the axis of the hinges 6 from the track 30, subject to the location of the axis of the wheel 41 on the second panel 2. Mounting the wheel 41 further towards the second side 2b of the second panel 2 will result in a smaller spacing between the edges of the panels.

It may be advantageous for the length of throw L1 to be close to the length of throw L2, but not equal. A throw L1 less than the throw L2 allows the first hinge leaf 21 to overlap and fit within the second hinge leaf 22, enabling the first panel 1 and second panel 2 to be brought to the closed configuration. The difference in the lengths of throws L1 and L2 is equal to the gap between the first panel 1 and second panel 2, in the closed position (provided the second hinge leaf portions 21b and 22b are rebated and mounted flush with the edges of the panels). Since a small gap between the first panel 1 and second panel 2 is visually appealing and creates a better closure of the opening, it is advantageous for the length of throw L1 to be as close as possible to length of L2. The intermediate hinge 20 advantageously provides for a minimal gap between the first panel 1 and second panel 2, which in this preferred embodiment may be 2 mm or smaller, for example.

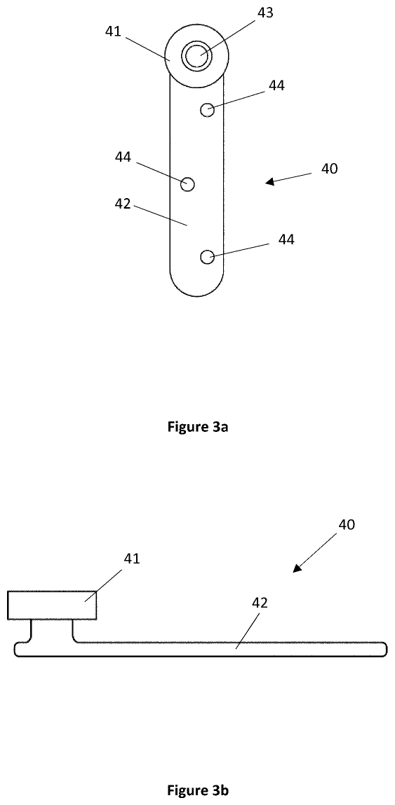

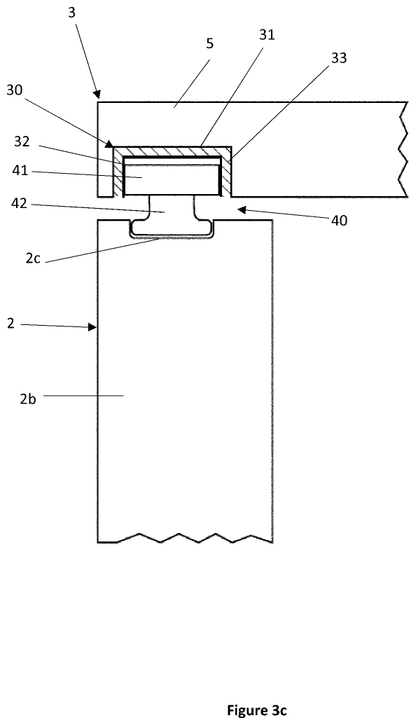

As shown in FIGS. 2c and 3c, the forward surfaces of the first panel 1 and second panel 2 are flush with the forward surface of the header 5 and frame 3, in the closed configuration. This is achieved by designing the bifold system 100 such that:
the first panel 1 is hinged to the jamb 4a of the frame 3 so that the first panel 1 is flush with the frame in the closed configuration, and
the track 30 in the header 5 and the wheel 41 on the second panel 2 are aligned and positioned such that when the wheel 41 is within the track 30, the second panel 2 is also flush with the frame 3.

Therefore, the offset in the forward direction between the axes about which the first panel 1 and the second panel 2 each pivot, is produced in part by the panels being mounted flush with the frame. The intermediate hinges 20 accommodate for this offset, thereby advantageously allowing the panels to be mounted flush with the frame 3, and to be of the same size as each other.

The intermediate hinges 20 in this preferred embodiment are configured to fit within hinge rebates that are configured to receive standard size hinges, although the scope of the invention is not limited to any particular hinge rebate sizes. In this embodiment, each of the first hinge leaf 21 and the second hinge leaf 22 is configured to fit within a 90 mm hinge rebate. Accordingly, the first hinge leaf 21 and second hinge leaf 22 each comprise a nominal height of 90 mm. In this embodiment, the first hinge leaf 21 and second hinge leaf 22 are each configured to fit within a 30 mm wide hinge rebate. For similar reasons to those explained above, by configuring the intermediate hinges 20 to fit into standard size hinge rebates, it may be easy for door manufactures to produce doors configured to receive the intermediate hinges 20 without requiring significant machine and jig reconfiguration.

As shown in FIGS. 1a and 1 b, the first hinge leaf 21 and second hinge leaf 22 each comprise holes 24 configured to receive fasteners for securing the intermediate hinge 20 to the first panel 1 and the second panel 2. In this embodiment, each of the first hinge leaf 21 and second hinge leaf 22 comprises three holes 24 for receiving fasteners, such as screws.

FIGS. 1c and 3c show the track 30 which extends along the header 5 of the frame 3 in the bifold system 100. In some embodiments, the track may be a downwardly opening slot (e.g. a channel) cut into the header. In this preferred embodiment, the track 30 comprises a track member 31 mounted to the header 5. As shown, the track member 31 is rebated into the header 5. The track member 31 is completely rebated so that it does not extend proud of the inside surface of the header 5. The header 5 comprises a recess configured to receive the track member 31, and the track member 31 is mounted to the header 5 within the recess. In this embodiment, the recess is a slot in the header 5 above the opening. It may be considered appealing to the eye for the track 30 to be hidden within the header 5. Another advantage of recessing the track 30 is that the track 30 does not reduce the effective opening height and area.

In this embodiment, the track member 31 comprises a channel shaped member. The track member 31 is supported by the header 5 to open downwardly. The track member 31 comprises two sides 32 and 33, formed by the two parallel opposing side portions of the channel shape. The wheel 41 connected to the second panel 2 is configured to roll along sides 31 and 32 of the track (but not both at the same time). The sides 31 and 32 are vertically oriented surfaces that extend along the length of the track 30.

The track member may be formed by any suitable means and from any suitable material. In this embodiment, the track member 31 comprises an aluminium extrusion. In other embodiments, the track member may be formed from another metal, such as stainless steel, or from a plastic material. In other embodiments, the track may not be formed form an extrusion and may be formed from another process, such as folding or moulding. In this embodiment, the track member 31 is glued into the header 5. In other embodiments, the track member may be secured in the header using another means, such as fastened with screws. Gluing is preferred since there is a possibility that fasteners could loosen.

FIGS. 3a and 3b show plan and side views, respectively, of a wheel bracket 40 according to an embodiment of the invention. In the bifold system 100, the wheel 41 is rotatably mounted on the wheel bracket 40 and the wheel bracket 40 is mounted to the second panel 2, to connect the wheel to the second panel 2. The wheel bracket 40 is mounted towards the second side 2b of the second panel 2, so as to mount the wheel 41 proximate the second side of 2b of the second panel 2.

Mounting the wheel 41 close to the second side 2b of the second panel 2 advantageously reduces the amount of spacing between the second side 1b of the first panel 1 and the first side 2a of the second panel 2, provided by the intermediate hinges 20 when the first panel 1 and second panel 2 are in the open configuration. Locating the wheel 41 further away from the first side 2a of the second panel 2 increases the length of the second panel 2 between the axis about which the second panel pivots (the axis of the wheel 41) and the first side 2a of the first panel 1. This results in a smaller gap between the second side 1b of the first panel 1 and the first side 2a, since the first panel 1 pivots about the barrel of the hinges 6, which is substantially in line with the first side 1a of the first panel 1.

The wheel bracket 40 in this preferred embodiment comprises a body 42 configured to be mounted to the second panel 2. The body 42 comprises a planar portion configured to be mounted to the second panel 2. The planar portion of the body 42 of the wheel bracket 40 comprises holes 44 for receiving fasteners to mount the wheel bracket 40 to the second panel 2. In this embodiment, the second panel 2 comprises a recess 2c in its upper edge surface, configured to receive the body 42 of the wheel bracket. Rebating the body 42 into the second panel 2 may make the bifold system 100 more appealing to the eye. In alternative embodiments the wheel bracket may be designed to mount to the face of the panel proximate the edge, however this is less preferred than a wheel bracket mounted to the top edge of the panel, since it may be less aesthetically pleasing and may result in a bigger offset between the edges of the panels when opened.

The body 42 also supports a pin 43 on which the wheel 41 is rotatably mounted. In this embodiment, the wheel 41 is rotatable mounted on a bearing assembly. More particularly, the bearing assembly is a ball bearing assembly. In other embodiments, other types of bearings may be used, such as roller bearings.

In this embodiment, the wheel 41 is formed from nylon. In other embodiments, any suitable material may be used, such as steel. In this embodiment, body 42 of the wheel bracket 40 is formed from any suitably material, such as aluminium or steel.

Preferred embodiments of the invention also involve methods of constructing bifold systems. With reference to the FIG.FIGs., one method comprises constructing a bifold system 100 integrated with a frame 3 comprising a jamb 4a and a header 5 together at least partially defining an opening 101. The method involves providing a track 30 extending along the header 5 in a transverse direction across the opening 101. Furthermore, the method involves hingedly connecting a first side 1a of a first panel 1 to the jamb 4a of the frame 3 such that the first panel 1 is able to pivot about a vertical axis spaced with respect to the track 30 in a forward direction with respect to the opening.

A first side 2a of a second panel 2 is connected to a second side 1b of the first panel 1 with at least one intermediate hinge 20. The one or more intermediate hinges 20 enable the first panel 1 and the second panel 2 to be moved between a closed configuration and an open configuration. A wheel 41 is connected to the second panel 2 towards a second side 2b of the second panel 2 such that the wheel 41 is rotatably mounted on a vertical axis and configured to guidedly travel along the track 30. For the reasons explained above, when the first panel 1 and the second panel 2 are in the open configuration, the intermediate hinge 20 offsets the second side 1b of the first panel 1 from the first side 2a of the second panel 2 by a spacing A towards the frame 3.

In preferred embodiments, the method also involves mounting a wheel bracket 40 to the second panel 2, the wheel bracket 40 having the wheel 41 rotatably mounted thereon. Additionally, in preferred embodiments the method comprises mounting a track member 31 to the header 5 of the frame 3. The track member is configured to guide the wheel 41 to travel along the track member 31.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A bifold system comprising:
a frame comprising a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the frame;
a second panel having a first side and a second side opposite the first side;
at least one intermediate hinge connecting the first side of the second panel to the second side of the first panel, the at least one intermediate hinge enabling the first panel and the second panel to be moved between a closed configuration and an open configuration;
a wheel connected to the second panel towards the second side of the second panel, the wheel being rotatably mounted on a vertical axis and configured to guidedly travel along the track, and
wherein, when the first panel and the second panel are in the open configuration, the intermediate hinge offsets the second side of the first panel from the first side of the second panel by a spacing in the forward direction.

2. The bifold system of claim 1, wherein the bifold system comprises a bifold door system, the first panel and the second panel comprising door panels.

3. The bifold system of claim 1 or claim 2, wherein the intermediate hinge comprises a first hinge leaf and a second hinge leaf connected to the first hinge leaf, the first hinge leaf and second hinge leaf being pivotable with respect to each other about a common axis.

4. The bifold system of claim 3, wherein the common axis is spaced from the second side of the first panel towards the first side of the first panel.

5. The bifold system of claim 3 or claim 4, wherein each of the first hinge leaf and the second hinge leaf comprises a first hinge leaf portion extending away from the common axis and a second hinge leaf portion extending away from the first hinge leaf portion at an angle to the first hinge leaf portion.

6. The bifold system of claim 5, wherein the angle to the first hinge leaf portion is a substantially perpendicular angle.

7. The bifold system of claim 5 or claim 6, wherein the second hinge leaf portion of the first hinge leaf is secured to a surface on an edge of the first panel, and the second hinge leaf portion of the second hinge leaf is secured to a surface on an edge of the second panel.

8. The bifold system of any one of claims 3-7, wherein when the first panel and second panel are in the closed configuration, the second hinge leaf overlaps the first hinge leaf.

9. The bifold system of claim 8 when dependent on claim 5, wherein when the first panel and the second panel are in the closed configuration, the first hinge leaf portion of the first hinge leaf is aligned parallel with and abutting the first hinge leaf portion of the second hinge leaf, and the second hinge leaf portion of the first hinge leaf is aligned parallel with and abutting the second hinge leaf portion of the second hinge leaf.

10. The bifold system of any one of claims 3-9, wherein when the first panel and the second panel are in the open configuration, the first hinge leaf is located on an opposite side of the common axis to the second hinge leaf.

11. The bifold system of claim 10 when dependent on claim 5, wherein when the first panel and the second panel are in the open configuration, the second hinge leaf portion of the first hinge leaf is parallel to and spaced from the second hinge leaf portion of the second hinge leaf in the forward direction by the spacing of the second side of the first panel from the first side of the second panel.

12. The bifold system of any one of claims 3-11, wherein each of the first hinge leaf and the second hinge leaf are configured to fit within a hinge rebate having a height of 90 mm and a width of 30 mm.

13. The bifold system of any one of claims 1-12, wherein the track comprises a track member mounted to the header.

14. The bifold system of claim 13, wherein the header comprises a recess configured to receive the track member, and the track member is mounted to the header in the recess.

15. The bifold system of claim 13 or claim 14, wherein the track member comprises channel shaped member.

16. The bifold system of any one of claims 13-15, wherein the track member is supported by the header to open downwardly.

17. The bifold system of any one of claims 1-16, wherein the wheel is rotatably mounted on a wheel bracket, the wheel bracket being mounted to the second panel.

18. The bifold system of claim 17, wherein the wheel bracket is mounted to a top edge of the second panel.

19. The bifold system of claim 17 or claim 18, wherein the wheel bracket comprises a body configured to be fixed to the second panel.

20. The bifold system of claim 19, wherein the body is planar.

21. The bifold system of claim 19 or claim 20, wherein the body of the wheel bracket comprises holes configured to receive fasteners for fixing the wheel bracket to the second panel.

22. A bifold kit for a bifold system, the bifold system comprising:
a frame having a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the opening; and
a second panel having a first side and a second side opposite the first side of the second panel,
the bifold kit comprising:
at least one intermediate hinge configured to connect the first side of the second panel to the second side of the first panel, the intermediate hinge enabling the first panel and the second panel to be moved between a closed configuration and an open configuration;
a wheel configured to be connected to the second panel towards the second side of the second panel so as to be rotatably mounted on a vertical axis and configured to guidedly travel along the track, and
wherein when the first panel and the second panel are in the open configuration, the intermediate hinge offsets the second side of the first panel from the first side of the second panel by a spacing in the forward direction.

23. The bifold kit of claim 22, comprising a wheel bracket having a body configured to be mounted to the second panel, the wheel rotatably mounted to the body of the wheel bracket.

24. The bifold kit of claim 22 or claim 23, comprising a track member configured to be mounted to the header, the track member configured to receive the wheel and guide the wheel to travel along the track.

25. A method of installing a bifold system in a frame comprising a jamb and a header together at least partially defining an opening, the method comprising:
providing a track extending along the header in a transverse direction across the opening;
hingedly connecting a first side of a first panel to the jamb so as to pivot about a vertical axis spaced with respect to the track in a forward direction with respect to the opening;
connecting a first side of a second panel to a second side of the first panel opposite the first side of the first panel with at least one intermediate hinge enabling the first panel and the second panel to be moved between a closed configuration and an open configuration; and
connecting a wheel to the second panel towards a second side of the second panel such that the wheel is rotatably mounted on a vertical axis and configured to guidedly travel along the track,
wherein when the first panel and the second panel are in the open configuration, the intermediate hinge offsets the second side of the first panel from the first side of the second panel by a spacing in the forward direction.

26. The method of claim 25, comprising mounting a wheel bracket to the second panel, the wheel bracket having the wheel rotatably mounted thereon.

27. The method of claim 25 or claim 26, comprising mounting a track member to the header, the track member configured to guide the wheel to travel along the track member.

28. An intermediate hinge for a bifold system, the bifold system comprising:
a frame having a jamb and a header together at least partially defining an opening;
a track extending along the header in a transverse direction across the opening;
a first panel having a first side and a second side opposite the first side, the first panel being hinged to the jamb at the first side of the first panel to pivot about a vertical axis spaced with respect to the track in a forward direction with respect to the opening;
a second panel having a first side and a second side opposite the first side of the second panel; and
a wheel connected to the second panel towards the second side of the second panel, the wheel being rotatably mounted on a vertical axis and configured to guidedly travel along the track,
the intermediate hinge comprising:
a first hinge leaf and a second hinge leaf connected to the first hinge leaf, the first hinge and second hinge leaf configured to pivot with respect to each other about a common axis;
wherein the intermediate hinge is configured to connect the first side of the second panel to the second side of the first panel and enable the first panel and the second panel to be moved between a closed configuration and an open configuration,
wherein when the first panel and the second panel are in the open configuration, the intermediate hinge offsets the second side of the first panel from the first side of the second panel by a spacing in the forward direction.

29. The intermediate hinge as claimed in claim 28, wherein each of the first hinge leaf and the second hinge leaf comprises a first hinge leaf portion extending away from the common axis and a second hinge leaf portion extending away from the first hinge leaf portion at an angle to the first hinge leaf portion.

30. The intermediate hinge as claimed in claim 29, wherein the angle to the first hinge leaf portion is substantially 90 degrees.
